(19) United States
(12) Patent Application Publication
(10) Pub. No.: US 2019/0044832 A1
(43) Pub. Date: Feb. 7, 2019

(54) TECHNOLOGIES FOR OPTIMIZED QUALITY OF SERVICE ACCELERATION

(71) Applicant: Intel Corporation, Santa Clara, CA (US)

(72) Inventors: Manasi Deval, Portland, OR (US); Duke Hong, Hillsboro, OR (US); Yashaswini Raghuram Prathivadi Bhayankaram, Hillsboro, OR (US)

(21) Appl. No.: 16/022,815

(22) Filed: Jun. 29, 2018

Related U.S. Application Data
(60) Provisional application No. 62/644,040, filed on Mar. 16, 2018.

(51) Int. Cl. H04L 12/24

(52) U.S. Cl. CPC H04L 41/5025; H04L 41/0896; H04L 41/0816

(57) ABSTRACT

Technologies for configuring network quality of service (QoS) parameters include a computing device having a network controller with a scheduler tree. The computing device creates a QoS node for a QoS parameter in a shared layer of a driver QoS tree. The node has status set to exclusive and is associated with a timestamp. If the node is associated with multiple entities, the status may be set to shared. The computing device programs the network controller with a QoS node for the QoS parameter in a shared layer of the scheduler tree. The computing device determines whether available nodes in the shared layer are below a threshold. If so, the computing device finds an oldest exclusive QoS node in the shared layer of the driver QoS tree and moves the node to an exclusive layer of the driver QoS tree and the scheduler tree. Other embodiments are described and claimed.

### CROSS-REFERENCE TO RELATED APPLICATION

The present application claims the benefit of U.S. Provisional Patent Application No. 62/644,040, filed Mar. 16, 2018.

### BACKGROUND

A Cloud Service Provider provides one or more components of a cloud computing environment (e.g., platform, infrastructure, application, storage, or other cloud services) to multiple tenants, such as businesses, individuals, or other entities. In a virtualized CSP environment, the hypervisor layer may provide value added services like packet monitoring, metering, and modifications based on the tunneling schemes in place. In certain circumstances (e.g., for 40 Gbps and higher speeds), hypervisor overhead may be reduced by performing network operations in a single-root I/O virtualization (SR-IOV) mode. In this mode, the services provided by the hypervisor may be provided by the hardware in a trusted mode. These services may include Access Control Lists (ACL) that drop or allow flows based on control plane policy, and tunnel endpoint which provides packet modifications to add or strip tunnel headers, and rate limiting or bandwidth guarantees on a single flow or groups of flows.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for optimized quality of service (QoS) acceleration;

FIG. 2 is a simplified block diagram of at least one embodiment of an environment of a computing device of FIG. 1;

FIG. 3 is a simplified flow diagram of at least one embodiment of a method for programming QoS acceleration of a network interface controller that may be executed by a computing device of FIGS. 1-2;

FIG. 4 is a simplified flow diagram of at least one embodiment of a method for optimizing QoS acceleration of a network interface controller that may be executed by a computing device of FIGS. 1-2;

FIG. 5 is a schematic diagram illustrating a scheduler tree of a network interface controller of FIGS. 1-4; and

FIG. 6 is a schematic diagram illustrating an optimized scheduler tree of a network interface controller of FIGS. 1-4.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

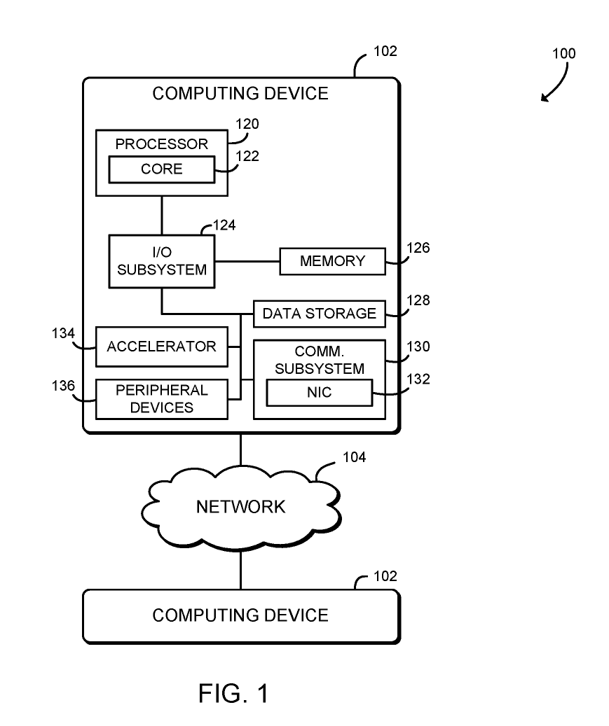

Referring now to FIG. 1, a system 100 for optimized QoS acceleration includes multiple computing devices 102 in communication over a network 104. Each computing device includes hardware accelerator support for traffic shaping or other quality of service (QoS) operations. In use, the computing device 102 initially uses shared bandwidth resources for every bandwidth configuration. Shared bandwidth resources include bandwidth limits, bandwidth guarantees, or other scheduler resources that are shared by multiple QoS entities, such as queues, virtual machines, traffic classes, or other entities. The driver monitors the use of shared resources to infer if the shared resource is really shared or may actually be an individual characteristic. If a given bandwidth characteristic was not shared with another entity, the shared bandwidth characteristic is seamlessly re-configured to use an individual bandwidth resource and release the shared resource. The shared resource may further be used for bandwidth characteristic configurations where it is either shared or its sharing status has not yet been determined. The system 100 may improve on existing techniques by dynamically inferencing the requirements of the control plane (e.g., determining requirements at runtime based on observed behavior), which may allow users to efficiently use scheduler node resources. Accordingly, the system 100 supports fine grained quality of service (QoS) rules with cost-effective hardware. As described further below, schedulers may be implemented as trees in the hardware, where the tree provides many more individual scheduler nodes than shared nodes. Dynamically inferencing whether a resource is individual or shared may reduce the number of shared resources that are used, which may allow the use of cost effective hardware (e.g., by reducing the size or expense of the hardware) and/or allow for supporting additional shared entities. Additionally, the system 100 may perform QoS optimization with minimal disruption of network traffic.

Each computing device 102 may be embodied as any type of computation or computer device capable of performing the functions described herein, including, without limitation, a computer, a server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. As shown in FIG. 1, the computing device 102 illustratively include a processor 120, an input/output subsystem 124, a memory 126, a data storage device 128, a communication subsystem 130, an accelerator 134, and/or other components and devices commonly found in a server or similar computing device. Of course, the computing device 102 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 126, or portions thereof, may be incorporated in the processor 120 in some embodiments.

The processor 120 may be embodied as any type of processor capable of performing the functions described herein. The processor 120 is illustratively a multi-core processor, however, in other embodiments the processor 120 may be embodied as a single or multi-core processor(s), digital signal processor, microcontroller, or other processor or processing/controlling circuit. The illustrative processor 120 includes multiple processor cores 122, each of which is an independent, general-purpose processing unit capable of executing programmed instructions. For example, each processor core 122 may execute instructions from a general-purpose instruction set architecture (ISA) such as IA-32 or Intel® 64. Although illustrated with one processor core 122, in some embodiments the processor 120 may include a larger number of processor cores 122, for example four processor cores 122, fourteen processor cores 122, twenty-eight processor cores 122, or a different number. Additionally, although illustrated as including a single processor 120, in some embodiments the computing device 102 may be embodied as a multi-socket server with multiple processors 120.

The memory 126 may be embodied as any type of volatile or non-volatile memory or data storage capable of performing the functions described herein. In operation, the memory 126 may store various data and software used during operation of the computing device 102 such operating systems, applications, programs, libraries, and drivers. The memory 126 is communicatively coupled to the processor 120 via the I/O subsystem 124, which may be embodied as circuitry and/or components to facilitate input/output operations with the processor 120, the accelerator 134, the memory 126, and other components of the computing device 102. For example, the I/O subsystem 124 may be embodied as, or otherwise include, memory controller hubs, input/output control hubs, sensor hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 124 may form a portion of a system-on-a-chip (SoC) and be incorporated, along with the processor 120, the memory 126, and other components of the computing device 102, on a single integrated circuit chip.

The data storage device 128 may be embodied as any type of device or devices configured for short-term or long-term storage of data such as, for example, memory devices and circuits, memory cards, hard disk drives, solid-state drives, non-volatile flash memory, or other data storage devices. The computing device 102 also includes the communication subsystem 130, which may be embodied as any communication circuit, device, or collection thereof, capable of enabling communications between the computing device 102 and other remote devices over the computer network 104. For example, the communication subsystem 130 may be embodied as or otherwise include a network interface controller (NIC) 132 or other network controller for sending and/or receiving network data with remote devices. The NIC 132 may be embodied as any network interface card, network adapter, host fabric interface, network coprocessor, or other component that connects the computing device 102 to the network 104. The communication subsystem 130 may be configured to use any one or more communication technology (e.g., wired or wireless communications) and associated protocols (e.g., Ethernet, InfiniBand®, Bluetooth®, Wi-Fi®, WiMAX, 3G, 4G LTE, etc.) to effect such communication. In some embodiments, the communication subsystem 132 and/or the NIC 132 may form a portion of an SoC and be incorporated along with the processor 120 and other components of the computing device 102 on a single integrated circuit chip.

As shown in FIG. 1, the computing device 102 also may include the accelerator 134. The accelerator 134 may be embodied as a field-programmable gate array (FPGA), an application-specific integrated circuit (ASIC), an embedded digital logic block, a coprocessor, or other digital logic device capable of performing accelerated network functions. Although illustrated as separate components, it should be understood that in some embodiments the accelerator 134 may be incorporated in or otherwise coupled to the NIC 132. Additionally or alternative, in some embodiments, the accelerator 134 may be embodied as an FPGA included in a multi-chip package with the processor 120 and the NIC 132. The accelerator 134 may be coupled to the processor 120 and/or the NIC 132 via multiple high-speed connection interfaces including coherent and/or non-coherent interconnects.

The computing device 102 may further include one or more peripheral devices 136. The peripheral devices 136 may include any number of additional input/output devices, interface devices, and/or other peripheral devices. For example, in some embodiments, the peripheral devices 136 may include a touch screen, graphics circuitry, a graphical processing unit (GPU) and/or processor graphics, an audio device, a microphone, a camera, a keyboard, a mouse, a network interface, and/or other input/output devices, interface devices, and/or peripheral devices.

The computing devices 102 may be configured to transmit and receive data with each other and/or other devices of the system 100 over the network 104. The network 104 may be embodied as any number of various wired and/or wireless networks. For example, the network 104 may be embodied as, or otherwise include, a wired or wireless local area network (LAN), and/or a wired or wireless wide area network (WAN). As such, the network 104 may include any number of additional devices, such as additional computers, routers, and switches, to facilitate communications among the devices of the system 100. In the illustrative embodiment, the network 104 is embodied as a local Ethernet network.

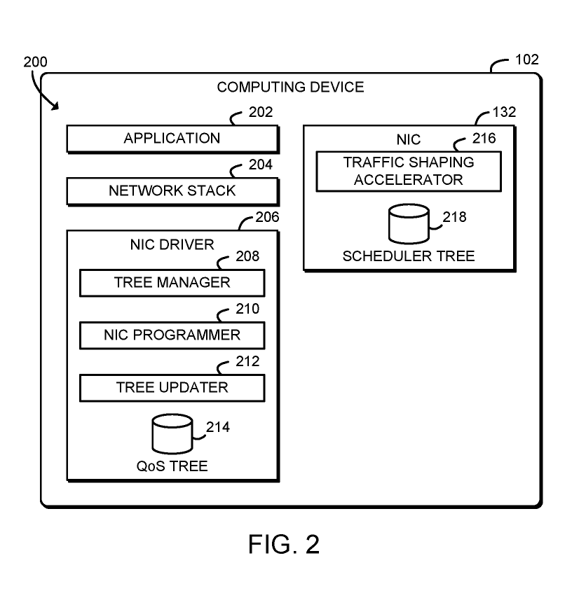

Referring now to FIG. 2, in an illustrative embodiment, the computing device 102 establishes an environment 200 during operation. The illustrative environment 200 includes an application 202, a network stack 204, a NIC driver 206, and the NIC 132. The NIC driver 206 further includes a tree manager 208, a NIC programmer 210, and a tree updater 212. The NIC 132 further includes a traffic shaping accelerator 216. As shown, the various components of the environment 200 may be embodied as hardware, microcode, firmware, software, or a combination thereof. As such, in some embodiments, one or more of the components of the environment 200 may be embodied as circuitry or collection of electrical devices (e.g., application circuitry 202, network stack circuitry 204, NIC driver circuitry 206, and/or traffic shaping accelerator circuitry 216). It should be appreciated that, in such embodiments, one or more of the application circuitry 202, the network stack circuitry 204, the NIC driver circuitry 206, and/or the traffic shaping accelerator circuitry 216 may form a portion of the processor 120, the NIC 132, the accelerator 134, the I/O subsystem 124, and/or other components of the computing device 102. In the illustrative embodiment, the application 202, the network stack 204, and the NIC driver 206 are executed by one or more processor cores 122 of the processor 120, and the traffic shaping accelerator 216 is embodied as hardware, firmware, microcode, or other resources of the NIC 132. Additionally or alternatively, in some embodiments, the traffic shaping accelerator 216 may be embodied as or otherwise included in one or more standalone accelerators 134. Additionally, in some embodiments, one or more of the illustrative components may form a portion of another component and/or one or more of the illustrative components may be independent of one another.

The application 202 may be configured to generate network data for transmission and/or to process received network data. For example, the application 202 may store packet data in one or more application buffers in the memory 126. The application 202 may be embodied as any client, server, or other network application executed by the computing device 102. In some embodiments, the application 202 may be embodied as a virtualized workload, such as a virtual machine. A virtual machine (VM) may include a partially or completely emulated computer system, including a guest operating system and one or more network queues. The VM may be executed using virtualization hardware support of the computing device 102, including virtualized I/O support of the processor 120 and/or the NIC 132. In some embodiments, each VM may access a dedicated virtual function of the NIC 132, for example in a single-root I/O virtualization (SR-IOV) mode.

The network stack 204 is configured to create quality of service (QoS) parameters and provide those QoS parameters to the NIC driver 206. The QoS parameters may include bandwidth limits, bandwidth guarantees, or other QoS parameters. The network stack 204 is further configured to create associations between QoS parameters and QoS entities, such as queues, virtual machines, traffic classes, or other entities. The network stack 204 is configured to provide the associations to the NIC driver 206.

The tree manager 208 is configured to create a QoS node for each QoS parameter in a shared layer of a QoS tree 214. The QoS tree 214 is maintained by the NIC driver 206, for example in the memory 126, and may be a copy of a scheduler tree 218 of the NIC 132, which is described further below. The tree manager 208 is configured to initially set the status of each QoS node to exclusive and to create a timestamp associated with each QoS node during creation. The tree manager 208 may be further configured to receive associations between QoS parameters and QoS entities, to determine whether a QoS parameter is associated with multiple QoS entities, and, if so, to set the status of that first QoS node to shared.

The NIC programmer 210 is configured to program the NIC 132 with a QoS node for the QoS parameter in a shared layer of the scheduler tree 218. The scheduler tree 218 may be embodied as memory, tables, registers, or other programmable storage of the NIC 132. As described further below, the NIC 132 may perform traffic shaping or other QoS operations based on the scheduler tree. The scheduler tree 218 may include multiple QoS nodes that are organized into layers, which each may be shared or exclusive. For example, in an embodiment the shared layer may be a virtual machine share layer and the exclusive layer may be a virtual machine layer. As another example, the shared layer may be a queue share layer and the exclusive layer may be a queue layer. The nodes of the scheduler tree 218 may be organized upward from a root corresponding to the network port of the NIC 132 up to leaf nodes that correspond to individual queues. As the tree is traversed from the leaf to the root, the number of nodes reduces, for example by a factor of 4 or 2. Thus, the NIC 132 may include support for more exclusive nodes than shared nodes.

The tree updater 212 is configured to determine whether a number of available nodes in a shared layer of the QoS tree 214 has a predetermined relationship to (e.g., less than, less than or equal to, etc.) a predetermined threshold (e.g., half of the total nodes in the shared layer). Each shared layer may be associated with a particular predetermined threshold. The tree updater 212 may be further configured to, if the number of available nodes has the predetermined relationship to the predetermined threshold, identify candidate nodes in the shared layer that have their status set to exclusive and, of those candidate nodes, identify an oldest candidate node based on the associated timestamps. The tree updater 212 is further configured to identified node to an exclusive layer of the QoS tree 214 and to move the corresponding node of the scheduler tree 218 to an exclusive layer of the scheduler tree 218. Moving the node to the exclusive layer may include programming the NIC 132 with a node for the corresponding QoS parameter in the exclusive layer of the scheduler tree 218 and releasing the node from the shared layer of the scheduler tree 218. the predetermined threshold comprises a half of total nodes of the shared layer.

The traffic shaping accelerator 216 is configured to shape network traffic of the computing device based on the scheduler tree 218 in response to programming the NIC 132. As described above, the scheduling nodes are arranged as a scheduler tree 218. Scheduler credits flow upward in the scheduler tree 218. If an entity (e.g., a queue, a VM, or a traffic class) associated with a scheduler node has credits, the entity may send traffic proportional to the credit.

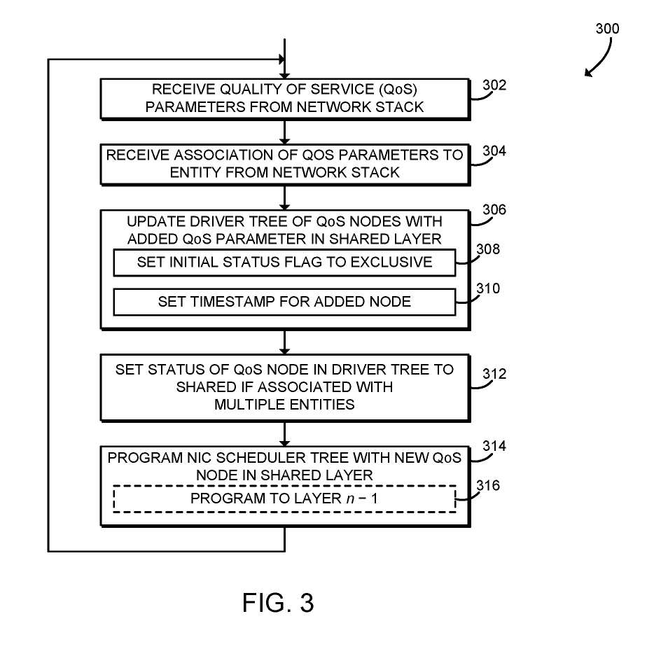

Referring now to FIG. 3, in use, the computing device 102 may execute a method 300 for programming QoS acceleration. It should be appreciated that, in some embodiments, the operations of the method 300 may be performed by one or more components of the environment 200 of the computing device 102 as shown in FIG. 2. The method 300 begins in block 302, in which the computing device 102 receives one or more quality of service (QoS) parameters from the network stack 204. For example, the QoS parameters may be received by the NIC driver 206. The QoS parameters may be embodied as a bandwidth limit, a bandwidth guarantee, or other QoS parameter specified by the network stack 204. In block 304, the computing device 102 receives an association of the QoS parameter to an entity from the network stack 204. The QoS parameter may be exclusive or shared among multiple entities such as queues, virtual machines (VMs), or traffic classes. The QoS parameters may ultimately depend on one or more service level agreements (SLA) in place with a tenant or other user of the computing device 102. For example, a QoS parameter such as a bandwidth limit may be shared by all VMs from a particular tenant that are executed by the computing device 102. However, VMs may be migrated or otherwise scheduled for execution on the computing device 102 by a fabric orchestrator or other control plane entity. Thus, the NIC driver 206 may not be aware of whether a QoS parameter is shared or exclusive when it is received from the network stack 204.

In block 306, the computing device 102 updates the QoS tree 214 maintained by the NIC driver 206 with the added QoS parameter in a shared layer. The computing device 102 may, for example, insert a new node into the QoS tree 214 that corresponds to the added QoS parameter. Because it is unknown at this point whether the node may be shared with multiple entities, the node is inserted in a shared layer, such as a queue share layer, VM share layer, or VM share aggregator layer of the QoS tree 214. In block 308, the computing device 102 sets the initial status flag of the node to exclusive. The status flag may be embodied as a bit or other Boolean value that indicates whether the node is shared or exclusive. Thus, by default, nodes are inserted into a shared layer but are marked as exclusive. In block 310, the computing device 102 sets a timestamp for the newly added node. The timestamp may be set as, for example, the time when the node was added to the QoS tree 214.

In block 312, the computing device 102 may set the status of a QoS node in the driver QoS tree 214 to shared if that node is associated with multiple entities. For example, the computing device 102 may determine that a QoS parameter is shared by multiple VMs (e.g., VMs from the same tenant or other user). In that example, the computing device 102 may set the status bit of the QoS node in the QoS tree 214 that corresponds to that QoS parameter to shared.

In block 314, the computing device 102 programs the scheduler tree 218 of the NIC 132 with a QoS node for the added QoS parameter in a shared layer. The computing device 102 programs the scheduler tree 218 with a node corresponding to the node added to the QoS tree 214. Thus, the QoS tree 214 may be a copy of the contents of the scheduler tree 218. In some embodiments, in block 316, the computing device 102 may program the node to a layer n−1. As described above, the scheduler tree 218 includes nodes arranged in layers from a root node to the leaf nodes. Thus, each layer may be described by a depth from the root node (e.g., depth n−1). After programming the NIC scheduler tree 218, the method 300 loops back to block 302 to continue processing QoS parameters.

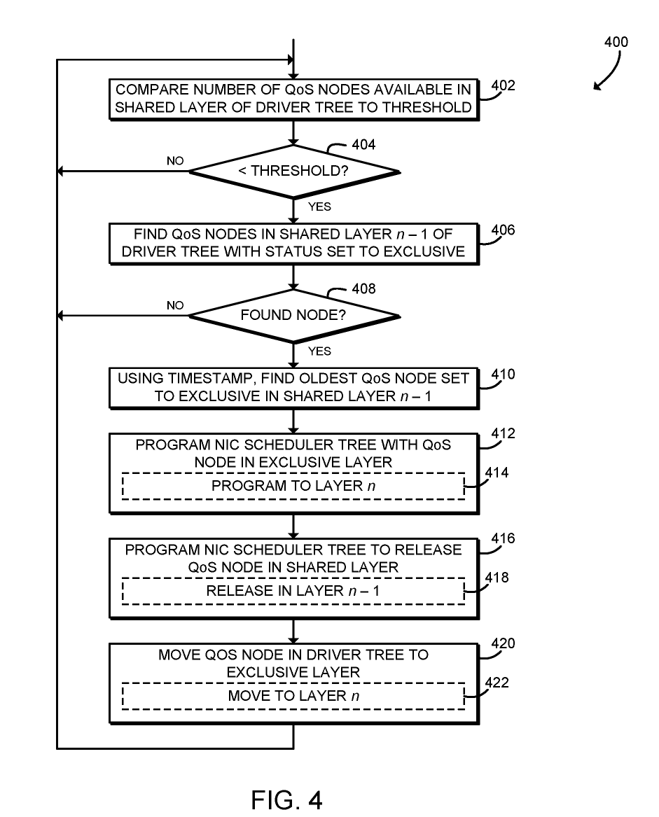

Referring now to FIG. 4, in use, the computing device 102 may execute a method 400 for optimizing QoS acceleration. It should be appreciated that, in some embodiments, the operations of the method 400 may be performed by one or more components of the environment 200 of the computing device 102 as shown in FIG. 2. The method 400 may be executed by the computing device 102 periodically, continually, or responsively. For example, the method 400 may be executed in a timer thread or other maintenance thread executed by the NIC driver 206. As another example, the method 400 may be executed in response to certain events, such as programming nodes to the scheduler tree 218 of the NIC 132. The method 400 begins in block 402, in which the computing device 102 compares the number of available QoS nodes in a shared layer of the driver QoS tree 214 to a predetermined threshold. The predetermined threshold may be any proportion or other amount of available nodes that indicate a shortcoming of shared nodes may exist. For example, the threshold may be half of the total nodes of a particular shared layer of the QoS tree 214. In block 404, the computing device 102 determines whether the number of available QoS nodes is less than the predetermined threshold (or otherwise has a predetermined relationship to the threshold). If not, the method 400 loops back to block 402 to continue optimizing the QoS acceleration. If the number of available QoS nodes is less than the threshold, the method 400 advances to block 406.

In block 406, the computing device 102 finds all QoS nodes in a shared layer n−1 with status set to exclusive. As described above, the shared layer may be a queue share layer, a VM share layer, a VM share aggregator layer, or other shared layer of the QoS tree 214. In block 408, the computing device 102 determines whether any exclusive QoS nodes were found. If not, the method 400 loops back to block 402 to continue optimizing QoS acceleration. If exclusive QoS nodes were found, the method 400 advances to block 410.

In block 410, the computing device 102 finds the oldest exclusive QoS node in the shared layer n−1, using the timestamps associated with each QoS node. In block 412, the computing device 102 programs the scheduler tree 218 of the NIC 132 with a QoS node that corresponds to the oldest exclusive QoS node into an exclusive layer of the scheduler tree 218. For example, the computing device 102 may program the new node into a queue layer, a VM layer, or other exclusive layer of the scheduler tree 218. The node created in exclusive layer of the scheduler tree 218 thus corresponds to the same QoS parameters and entities of the node previously created in the shared layer. In some embodiments, in block 410 the computing device 102 may program the new QoS node into a layer n of the scheduler tree 218. As described above, the shared layer is layer n−1, and thus the layer n is one layer further away from the root of the scheduler tree. The layer n may have more available nodes than the layer n−1 (e.g., twice or four times as many nodes).

In block 416, the computing device 102 programs the scheduler tree 218 of the NIC 132 to release a node corresponding to the oldest exclusive QoS node from the shared layer. Releasing the node may free up the node to be used for scheduling shared entities. In some embodiments, in block 418, the computing device 102 may release the node in layer n−1 of the scheduler tree 218.

In block 420, the computing device 102 moves the oldest exclusive node found in the driver QoS tree 214 to an exclusive layer. After moving the node, the QoS tree 214 may be a copy of the scheduler tree 218 of the NIC 132. In some embodiments, in block 422 the computing device 102 may move the node from layer n−1 to layer n. After updating the QoS tree 214, the method 400 loops back to block 402 to continue optimizing the QoS acceleration. In some embodiments, the method 400 may be executed recursively or otherwise repeatedly on multiple different nodes and/or layers of the driver QoS tree 214. For example, the method 400 may be executed repeatedly until the number of QoS nodes available in the shared layer is above the threshold. As another example, the method 400 may be executed recursively, concurrently, or otherwise repeatedly for each shared layer of the Qos tree 214.

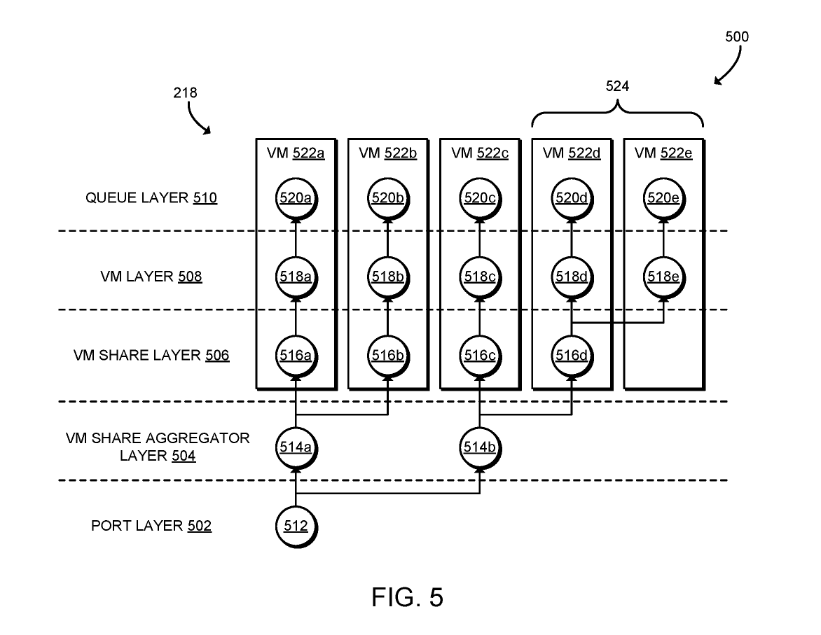

Referring now to FIG. 5, diagram 500 illustrates a scheduler tree 218 that may be programmed to the NIC 132. As shown, arranged from the root to the leaf nodes, the scheduler tree 218 includes a port layer 502, a VM share aggregator layer 504, a VM share layer 506, a VM layer 508, and a queue layer 510. In the illustrative embodiment, the VM layer 508 is an exclusive layer, and the VM share layer 506 and the VM share aggregator layer 504 are shared layers. Of course, in other embodiments the scheduler tree 218 may include a different number and/or arrangement of layers, such as a queue share layer. The port layer 502 includes a node 512, the VM share aggregator layer 504 includes nodes 514, the VM share layer 506 includes nodes 516, the VM layer 508 includes nodes 518, and the queue layer 510 includes nodes 520.

FIG. 5 illustrates one potential embodiment of the scheduler tree 218 after being configured with multiple nodes as described in connection with FIG. 3 but before being optimized as described in connection with FIG. 4. Illustratively, QoS nodes for VMs 522a, 522b, 522c, 522d, 522e have been programmed to the scheduler tree 218. In the illustrative example, VMs 522a, 522b, 522c are not shared entities, and VMs 522d, 522e are shared. As shown, each of VMs 522a, 522b, 522c are initially added to the scheduler tree 218 using shared nodes, in particular shared nodes 516a, 516b, 516c. VMs 522d, 522e, which may be known to be shared entities by the NIC driver 206, were added using a shared node 516d.

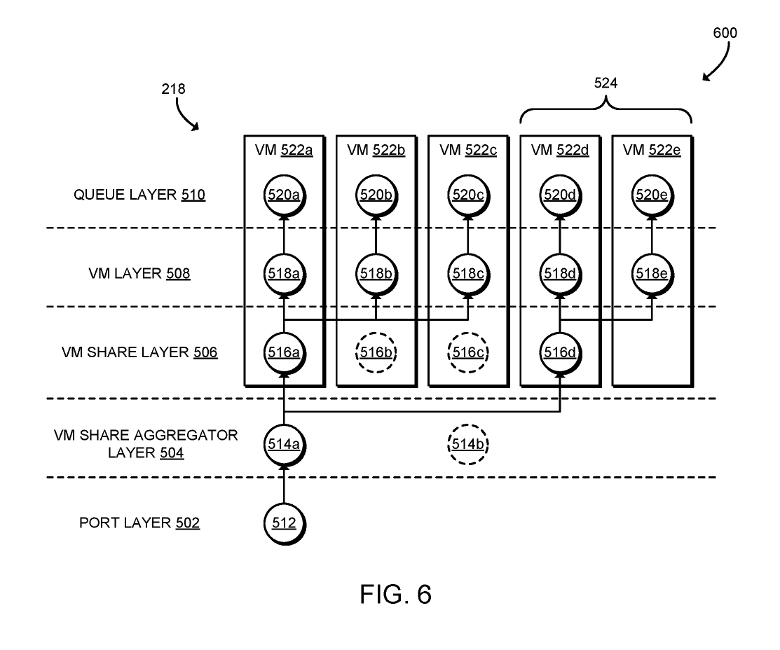

Referring now to FIG. 6, diagram 600 illustrates the scheduler tree 218 of the NIC 132 after performing optimization as described above in connection with FIG. 4. As shown, because the VMs 522a, 522b, 522c are not shared entities, the nodes 516b, 516c in the VM share layer 506 were released. The corresponding QoS nodes for those VMs 522a, 522b, 522c may be instead created in the VM layer 508 as nodes 518a, 518b, 518c, respectively. Similarly, because the number of nodes used in the VM share layer 506 was reduced, the node 514b in the VM share aggregator layer 504 was also released. Releasing shared nodes as shown in FIG. 6 reduces resource consumption and may allow the NIC 132 to support a larger number of entities (shared and/or exclusive).

It should be appreciated that, in some embodiments, the methods 300 and/or may be embodied as various instructions stored on a computer-readable media, which may be executed by the processor 120, the NIC 132, the accelerator 134, and/or other components of the computing device 102 to cause the computing device 102 to perform the respective method 300 and/or 400. The computer-readable media may be embodied as any type of media capable of being read by the computing device 102 including, but not limited to, the memory 126, the data storage device 128, firmware devices, microcode, other memory or data storage devices of the computing device 102, portable media readable by a peripheral device 136 of the computing device 102, and/or other media.

### Examples

Illustrative examples of the technologies disclosed herein are provided below. An embodiment of the technologies may include any one or more, and any combination of, the examples described below.

Example 1 includes a computing device for configuring network quality of service parameters, the computing device comprising: a network controller that includes a scheduler tree; a driver tree manager to create a first QoS node for a QoS parameter in a shared layer of a driver QoS tree; a network controller programmer to program the network controller with a second QoS node for the QoS parameter in a shared layer of the scheduler tree; and a driver tree updater to (i) determine whether a number of available nodes in the shared layer of the driver QoS tree has a predetermined relationship to a predetermined threshold in response to programming of the network controller, wherein the predetermined threshold is associated with the shared layer of the driver QoS tree; and (ii) in response to a determination that the number of available nodes has the predetermined relationship to the predetermined threshold, move the second QoS node to an exclusive layer of the scheduler tree of the network controller and move the first QoS node to an exclusive layer of the driver QoS tree.

Example 2 includes the subject matter of Example 1, and wherein the driver tree updater is further to: identify a plurality of candidate nodes in the shared layer of the driver QoS tree in response to the determination that the number of available nodes has the predetermined relationship to the predetermined threshold, wherein each of the plurality of candidate nodes has a status set to exclusive, and wherein the plurality of candidate nodes comprises the first QoS node; wherein to move the first QoS node to the exclusive layer comprises to move the first QoS node to the exclusive layer in response to identification of the plurality of candidate nodes.

Example 3 includes the subject matter of any of Examples 1 and 2, and wherein the driver tree updater is further to: identify an oldest candidate node of the plurality of candidate nodes, wherein each of the plurality of candidate nodes is associated with a timestamp, and wherein the oldest candidate node comprises the first QoS node; wherein to create the first QoS node comprises to create the timestamp associated with the first QoS node.

Example 4 includes the subject matter of any of Examples 1-3, and wherein to move the second QoS node to the exclusive layer comprises to: program the network controller with a third QoS node for the QoS parameter in the exclusive layer of the scheduler tree; and program the network controller to release the second QoS node from the shared layer of the scheduler tree.

Example 5 includes the subject matter of any of Examples 1-4, and wherein the driver tree manager is further to receive an association between the QoS parameter and a QoS entity, wherein the QoS entity comprises a queue, a virtual machine, or a traffic class.

Example 6 includes the subject matter of any of Examples 1-5, and wherein to create the first QoS node comprises to set a status of the first QoS node to exclusive; and the driver tree manager is further to: determine whether the QoS parameter is associated with multiple QoS entities; and set the status of the first QoS node to shared in response to a determination that the QoS parameter is associated with multiple QoS entities.

Example 7 includes the subject matter of any of Examples 1-6, and wherein the QoS parameter comprises a bandwidth limit or a bandwidth guarantee.

Example 8 includes the subject matter of any of Examples 1-7, and wherein the shared layer comprises a virtual machine share layer and wherein the exclusive layer comprises a virtual machine layer.

Example 9 includes the subject matter of any of Examples 1-8, and wherein the shared layer comprises a queue share layer and wherein the exclusive layer comprises a queue layer.

Example 10 includes the subject matter of any of Examples 1-9, and wherein the predetermined threshold comprises a half of total nodes of the shared layer.

Example 11 includes the subject matter of any of Examples 1-10, and wherein the network controller comprises a traffic shaping accelerator to shape network traffic of the computing device based on the scheduler tree in response to programming of the network controller.

Example 12 includes a method for configuring network quality of service parameters, the method comprising: creating, by the computing device, a first QoS node for a QoS parameter in a shared layer of a driver QoS tree; programming, by the computing device, a network controller of the computing device with a second QoS node for the QoS parameter in a shared layer of a scheduler tree of the network controller; determining, by the computing device, whether a number of available nodes in the shared layer of the driver QoS tree has a predetermined relationship to a predetermined threshold in response to programming the network controller, wherein the predetermined threshold is associated with the shared layer of the driver QoS tree; and in response to determining that the number of available nodes has the predetermined relationship to the predetermined threshold: moving, by the computing device, the second QoS node to an exclusive layer of the scheduler tree of the network controller; and moving, by the computing device, the first QoS node to an exclusive layer of the driver QoS tree.

Example 13 includes the subject matter of Example 12, and further comprising: identifying, by the computing device, a plurality of candidate nodes in the shared layer of the driver QoS tree in response to determining that the number of available nodes has the predetermined relationship to the predetermined threshold, wherein each of the plurality of candidate nodes has a status set to exclusive, and wherein the plurality of candidate nodes comprises the first QoS node; wherein moving the first QoS node to the exclusive layer comprises moving the first QoS node to the exclusive layer in response to identifying the plurality of candidate nodes.

Example 14 includes the subject matter of any of Examples 12 and 13, and further comprising: identifying, by the computing device, an oldest candidate node of the plurality of candidate nodes, wherein each of the plurality of candidate nodes is associated with a timestamp, and wherein the oldest candidate node comprises the first QoS node; wherein creating the first QoS node comprises creating the timestamp associated with the first QoS node.

Example 15 includes the subject matter of any of Examples 12-14, and wherein moving the second QoS node to the exclusive layer comprises: programming the network controller with a third QoS node for the QoS parameter in the exclusive layer of the scheduler tree; and programming the network controller to release the second QoS node from the shared layer of the scheduler tree.

Example 16 includes the subject matter of any of Examples 12-15, and further comprising receiving, by the computing device, an association between the QoS parameter and a QoS entity, wherein the QoS entity comprises a queue, a virtual machine, or a traffic class.

Example 17 includes the subject matter of any of Examples 12-16, and further comprising: determining, by the computing device, whether the QoS parameter is associated with multiple QoS entities; and setting, by the computing device, a status of the first QoS node to shared in response to determining that the QoS parameter is associated with multiple QoS entities; wherein creating the first QoS node comprises setting the status of the first QoS node to exclusive.

Example 18 includes the subject matter of any of Examples 12-17, and wherein the QoS parameter comprises a bandwidth limit or a bandwidth guarantee.

Example 19 includes the subject matter of any of Examples 12-18, and wherein the shared layer comprises a virtual machine share layer and wherein the exclusive layer comprises a virtual machine layer.

Example 20 includes the subject matter of any of Examples 12-19, and wherein the shared layer comprises a queue share layer and wherein the exclusive layer comprises a queue layer.

Example 21 includes the subject matter of any of Examples 12-20, and wherein the predetermined threshold comprises a half of total nodes of the shared layer.

Example 22 includes the subject matter of any of Examples 12-21, and further comprising shaping, by the network controller, network traffic of the computing device based on the scheduler tree in response to programming the network controller.

Example 23 includes one or more computer-readable storage media comprising a plurality of instructions stored thereon that, in response to being executed, cause a computing device to: create a first QoS node for a QoS parameter in a shared layer of a driver QoS tree; program a network controller of the computing device with a second QoS node for the QoS parameter in a shared layer of a scheduler tree of the network controller; determine whether a number of available nodes in the shared layer of the driver QoS tree has a predetermined relationship to a predetermined threshold in response to programming the network controller, wherein the predetermined threshold is associated with the shared layer of the driver QoS tree; and in response to determining that the number of available nodes has the predetermined relationship to the predetermined threshold: move the second QoS node to an exclusive layer of the scheduler tree of the network controller; and move the first QoS node to an exclusive layer of the driver QoS tree.

Example 24 includes the subject matter of Example 23, and further comprising a plurality of instructions stored thereon that, in response to being executed, cause the computing device to: identify a plurality of candidate nodes in the shared layer of the driver QoS tree in response to determining that the number of available nodes has the predetermined relationship to the predetermined threshold, wherein each of the plurality of candidate nodes has a status set to exclusive, and wherein the plurality of candidate nodes comprises the first QoS node; wherein to move the first QoS node to the exclusive layer comprises to move the first QoS node to the exclusive layer in response to identifying the plurality of candidate nodes.

Example 25 includes the subject matter of any of Examples 23 and 24, and further comprising a plurality of instructions stored thereon that, in response to being executed, cause the computing device to: identify an oldest candidate node of the plurality of candidate nodes, wherein each of the plurality of candidate nodes is associated with a timestamp, and wherein the oldest candidate node comprises the first QoS node; wherein to create the first QoS node comprises to create the timestamp associated with the first QoS node.

Example 26 includes the subject matter of any of Examples 23-25, and wherein to move the second QoS node to the exclusive layer comprises to: program the network controller with a third QoS node for the QoS parameter in the exclusive layer of the scheduler tree; and program the network controller to release the second QoS node from the shared layer of the scheduler tree.

Example 27 includes the subject matter of any of Examples 23-26, and further comprising a plurality of instructions stored thereon that, in response to being executed, cause the computing device to receive an association between the QoS parameter and a QoS entity, wherein the QoS entity comprises a queue, a virtual machine, or a traffic class.

Example 28 includes the subject matter of any of Examples 23-27, and further comprising a plurality of instructions stored thereon that, in response to being executed, cause the computing device to: determine whether the QoS parameter is associated with multiple QoS entities; and set a status of the first QoS node to shared in response to determining that the QoS parameter is associated with multiple QoS entities; wherein to create the first QoS node comprises to set the status of the first QoS node to exclusive.

Example 29 includes the subject matter of any of Examples 23-28, and wherein the QoS parameter comprises a bandwidth limit or a bandwidth guarantee.

Example 30 includes the subject matter of any of Examples 23-39, and wherein the shared layer comprises a virtual machine share layer and wherein the exclusive layer comprises a virtual machine layer.

Example 31 includes the subject matter of any of Examples 23-30, and wherein the shared layer comprises a queue share layer and wherein the exclusive layer comprises a queue layer.

Example 32 includes the subject matter of any of Examples 23-31, and wherein the predetermined threshold comprises a half of total nodes of the shared layer.

Example 33 includes the subject matter of any of Examples 23-32, and further comprising a plurality of instructions stored thereon that, in response to being executed, cause the computing device to shape, by the network controller, network traffic of the computing device based on the scheduler tree in response to programming the network controller.

1. A computing device for configuring network quality of service parameters, the computing device comprising:
a network controller that includes a scheduler tree;
a driver tree manager to create a first QoS node for a QoS parameter in a shared layer of a driver QoS tree;
a network controller programmer to program the network controller with a second QoS node for the QoS parameter in a shared layer of the scheduler tree; and
a driver tree updater to (i) determine whether a number of available nodes in the shared layer of the driver QoS tree has a predetermined relationship to a predetermined threshold in response to programming of the network controller, wherein the predetermined threshold is associated with the shared layer of the driver QoS tree; and (ii) in response to a determination that the number of available nodes has the predetermined relationship to the predetermined threshold, move the second QoS node to an exclusive layer of the scheduler tree of the network controller and move the first QoS node to an exclusive layer of the driver QoS tree.

2. The computing device of claim 1, wherein the driver tree updater is further to:
identify a plurality of candidate nodes in the shared layer of the driver QoS tree in response to the determination that the number of available nodes has the predetermined relationship to the predetermined threshold, wherein each of the plurality of candidate nodes has a status set to exclusive, and wherein the plurality of candidate nodes comprises the first QoS node;
wherein to move the first QoS node to the exclusive layer comprises to move the first QoS node to the exclusive layer in response to identification of the plurality of candidate nodes.

3. The computing device of claim 2, wherein the driver tree updater is further to:
identify an oldest candidate node of the plurality of candidate nodes, wherein each of the plurality of candidate nodes is associated with a timestamp, and wherein the oldest candidate node comprises the first QoS node;
wherein to create the first QoS node comprises to create the timestamp associated with the first QoS node.

4. The computing device of claim 1, wherein to move the second QoS node to the exclusive layer comprises to:
program the network controller with a third QoS node for the QoS parameter in the exclusive layer of the scheduler tree; and
program the network controller to release the second QoS node from the shared layer of the scheduler tree.

5. The computing device of claim 1, wherein the driver tree manager is further to receive an association between the QoS parameter and a QoS entity, wherein the QoS entity comprises a queue, a virtual machine, or a traffic class.

6. The computing device of claim 5, wherein:
to create the first QoS node comprises to set a status of the first QoS node to exclusive; and
the driver tree manager is further to: determine whether the QoS parameter is associated with multiple QoS entities; and set the status of the first QoS node to shared in response to a determination that the QoS parameter is associated with multiple QoS entities.

7. The computing device of claim 1, wherein the QoS parameter comprises a bandwidth limit or a bandwidth guarantee.

8. The computing device of claim 1, wherein the shared layer comprises a virtual machine share layer and wherein the exclusive layer comprises a virtual machine layer.

9. The computing device of claim 1, wherein the shared layer comprises a queue share layer and wherein the exclusive layer comprises a queue layer.

10. The computing device of claim 1, wherein the predetermined threshold comprises a half of total nodes of the shared layer.

11. The computing device of claim 1, wherein the network controller comprises a traffic shaping accelerator to shape network traffic of the computing device based on the scheduler tree in response to programming of the network controller.

12. A method for configuring network quality of service parameters, the method comprising:
creating, by the computing device, a first QoS node for a QoS parameter in a shared layer of a driver QoS tree;
programming, by the computing device, a network controller of the computing device with a second QoS node for the QoS parameter in a shared layer of a scheduler tree of the network controller;
determining, by the computing device, whether a number of available nodes in the shared layer of the driver QoS tree has a predetermined relationship to a predetermined threshold in response to programming the network controller, wherein the predetermined threshold is associated with the shared layer of the driver QoS tree; and
in response to determining that the number of available nodes has the predetermined relationship to the predetermined threshold:
moving, by the computing device, the second QoS node to an exclusive layer of the scheduler tree of the network controller; and
moving, by the computing device, the first QoS node to an exclusive layer of the driver QoS tree.

13. The method of claim 12, further comprising:
identifying, by the computing device, a plurality of candidate nodes in the shared layer of the driver QoS tree in response to determining that the number of available nodes has the predetermined relationship to the predetermined threshold, wherein each of the plurality of candidate nodes has a status set to exclusive, and wherein the plurality of candidate nodes comprises the first QoS node;
wherein moving the first QoS node to the exclusive layer comprises moving the first QoS node to the exclusive layer in response to identifying the plurality of candidate nodes.

14. The method of claim 13, further comprising:
identifying, by the computing device, an oldest candidate node of the plurality of candidate nodes, wherein each of the plurality of candidate nodes is associated with a timestamp, and wherein the oldest candidate node comprises the first QoS node;
wherein creating the first QoS node comprises creating the timestamp associated with the first QoS node.

15. The method of claim 12, wherein moving the second QoS node to the exclusive layer comprises:
programming the network controller with a third QoS node for the QoS parameter in the exclusive layer of the scheduler tree; and
programming the network controller to release the second QoS node from the shared layer of the scheduler tree.

16. The method of claim 12, further comprising receiving, by the computing device, an association between the QoS parameter and a QoS entity, wherein the QoS entity comprises a queue, a virtual machine, or a traffic class.

17. The method of claim 16, further comprising:
determining, by the computing device, whether the QoS parameter is associated with multiple QoS entities; and
setting, by the computing device, a status of the first QoS node to shared in response to determining that the QoS parameter is associated with multiple QoS entities;
wherein creating the first QoS node comprises setting the status of the first QoS node to exclusive.

18. The method of claim 12, further comprising shaping, by the network controller, network traffic of the computing device based on the scheduler tree in response to programming the network controller.

19. One or more computer-readable storage media comprising a plurality of instructions stored thereon that, in response to being executed, cause a computing device to:
create a first QoS node for a QoS parameter in a shared layer of a driver QoS tree;
program a network controller of the computing device with a second QoS node for the QoS parameter in a shared layer of a scheduler tree of the network controller;
determine whether a number of available nodes in the shared layer of the driver QoS tree has a predetermined relationship to a predetermined threshold in response to programming the network controller, wherein the predetermined threshold is associated with the shared layer of the driver QoS tree; and
in response to determining that the number of available nodes has the predetermined relationship to the predetermined threshold:
move the second QoS node to an exclusive layer of the scheduler tree of the network controller; and
move the first QoS node to an exclusive layer of the driver QoS tree.

20. The one or more computer-readable storage media of claim 19, further comprising a plurality of instructions stored thereon that, in response to being executed, cause the computing device to:
identify a plurality of candidate nodes in the shared layer of the driver QoS tree in response to determining that the number of available nodes has the predetermined relationship to the predetermined threshold, wherein each of the plurality of candidate nodes has a status set to exclusive, and wherein the plurality of candidate nodes comprises the first QoS node;
wherein to move the first QoS node to the exclusive layer comprises to move the first QoS node to the exclusive layer in response to identifying the plurality of candidate nodes.

21. The one or more computer-readable storage media of claim 20, further comprising a plurality of instructions stored thereon that, in response to being executed, cause the computing device to:
identify an oldest candidate node of the plurality of candidate nodes, wherein each of the plurality of candidate nodes is associated with a timestamp, and wherein the oldest candidate node comprises the first QoS node;
wherein to create the first QoS node comprises to create the timestamp associated with the first QoS node.

22. The one or more computer-readable storage media of claim 19, wherein to move the second QoS node to the exclusive layer comprises to:
program the network controller with a third QoS node for the QoS parameter in the exclusive layer of the scheduler tree; and
program the network controller to release the second QoS node from the shared layer of the scheduler tree.

23. The one or more computer-readable storage media of claim 19, further comprising a plurality of instructions stored thereon that, in response to being executed, cause the computing device to receive an association between the QoS parameter and a QoS entity, wherein the QoS entity comprises a queue, a virtual machine, or a traffic class.

24. The one or more computer-readable storage media of claim 23, further comprising a plurality of instructions stored thereon that, in response to being executed, cause the computing device to:
determine whether the QoS parameter is associated with multiple QoS entities; and
set a status of the first QoS node to shared in response to determining that the QoS parameter is associated with multiple QoS entities;
wherein to create the first QoS node comprises to set the status of the first QoS node to exclusive.

25. The one or more computer-readable storage media of claim 19, further comprising a plurality of instructions stored thereon that, in response to being executed, cause the computing device to shape, by the network controller, network traffic of the computing device based on the scheduler tree in response to programming the network controller.
